(19) United States
(12) Patent Application Publication
(10) Pub. No.: US 2014/0227515 A1
(43) Pub. Date: Aug. 14, 2014

(54) GAS BARRIER FILM

(71) Applicants: Masako Takano, Koga-shi (JP); Kiyotaka Shindo, Ichihara-shi (JP)

(72) Inventors: Masako Takano, Koga-shi (JP); Kiyotaka Shindo, Ichihara-shi (JP)

(73) Assignee: MITSUI CHEMICALS TOHCELLO, INC., Tokyo (JP)

(21) Appl. No.: 14/342,327

(22) PCT Filed: Sep. 3, 2012
(86) PCT No.: PCT/JP2012/072302

§ 371 Date: Feb. 28, 2014

(30) Foreign Application Priority Data
Sep. 5, 2011 (JP) 2011-192618

(51) Int. Cl. B32B 9/04; B65D 81/24; B32B 27/30

(52) U.S. Cl. CPC B32B 9/045; B32B 27/308; B65D 81/24; B32B 2250/04; B32B 2307/7244; B32B 2307/7246; B32B 2553/00
USPC 428/354; 428/447

(57) ABSTRACT

The present invention aims to provide a transparent gas barrier film having excellent gas barrier properties against oxygen, water vapor and the like especially under high humidity, and showing excellent delamination resistance after hydrothermal treatment. The present invention relates to a gas barrier film comprising: a base film having an inorganic compound layer formed on one side thereof; and a (meth)acrylic silane coupling agent layer and a layer (Y) that are laminated in this order on the inorganic compound layer, which layer (Y) comprises a polymer of a polyvalent metal salt of an unsaturated carboxylic acid compound (a) and a vinyl alcohol polymer (b).

### TECHNICAL FIELD

The present invention relates to a transparent gas barrier film having excellent gas barrier properties against oxygen, water vapor and the like, and showing excellent delamination resistance after hydrothermal treatment.

### BACKGROUND ART

Recent interest has focused on transparent gas barrier films as barrier materials against oxygen, water vapor and the like, which films are produced by forming, on a film substrate, an inorganic oxide such as silicon oxide, aluminium oxide or the like by vacuum deposition, sputtering method, ion plating, chemical vapor deposition or the like. Since such transparent gas barrier films are generally films produced by vapor deposition of an inorganic oxide on a substrate surface composed of a biaxially-stretched polyester film having excellent transparence and rigidity, the vapor-deposited layer per se is hardly resistant to friction and the like caused upon use of the film. Therefore, upon use of the film as a packaging film, upon performing aftertreatment such as printing or lamination, or upon filling the package with a content, friction or stretching may cause a crack to the inorganic oxide, resulting in a decreased gas barrier property.

On the other hand, methods wherein polyvinyl alcohol and ethylene/vinyl alcohol copolymer having gas barrier properties are laminated on a biaxially-stretched film substrate (for example, Patent Document 1) and a method wherein a biaxially-stretched film substrate is coated with a composition comprising polyvinyl alcohol and poly(meth)acrylic acid (for example, Patent Document 2) have been proposed. However, the gas barrier film produced by lamination of polyvinyl alcohol has a decreased oxygen barrier property under high humidity. Further, the composition comprising polyvinyl alcohol and poly(meth)acrylic acid requires heating at a high temperature for a long time in order to sufficiently allow their esterification and hence to increase the gas barrier properties of the film, so that there is a problem in the productivity of the film, and the gas barrier properties of the film under high humidity are insufficient. Further, the reaction at a high temperature for a long time causes coloring of the film and deteriorates its outer appearance, so that improvement is required for use in packaging of foods.

On the other hand, since the composition comprising polyvinyl alcohol and poly(meth)acrylic acid requires reaction at a high temperature for a long time in order to achieve esterification, methods wherein a crosslinking agent component such as an isocyanate compound is added to polyacrylic acid (for example, Patent Document 3) and methods wherein a reaction with a metal ion is performed (for example, Patent Document 4) have been proposed, but, also in such methods, treatment at a temperature of as high as 180 to 200° C. for 5 minutes is required for crosslinking of the polyacrylic acid with the crosslinking agent component, as described in Examples.

Further, a gas barrier film comprising: a base material layer (X); and a layer (Y) comprising a polymer of a polyvalent metal salt of an unsaturated carboxylic acid compound (a) whose ratio between the absorbance A₀ based on νC═O of the carboxylic acid group near 1700 cm⁻¹ in the infrared absorption spectrum and the absorbance A based on νC═O of the carboxylate ion near 1520 cm⁻¹ (A₀/A) is less than 0.25; is known, but the gas barrier properties of the film need to be improved (Patent Document 5).

However, it has been found that, in cases where the layer (Y) comprising a polymer of a polyvalent metal salt of an unsaturated carboxylic acid compound (a) is laminated on a layer of an inorganic compound such as silicon oxide, retort treatment of the laminate may decrease the adhesion.

### PRIOR ART DOCUMENTS

### Patent Documents

[Patent Document 1] JP 60-157830 A (Claims)
[Patent Document 2] JP 3203287 B (Claim 1)
[Patent Document 3] JP 2001-310425 A (Claim 1, Example 1)
[Patent Document 4] JP 2003-171419 A (Claim 1, Table 1)
[Patent Document 5] WO2005/108440 (Claim 1)

### SUMMARY OF THE INVENTION

### Problems to be Solved by the Invention

The present invention aims to provide a transparent gas barrier film having excellent gas barrier properties against oxygen, water vapor and the like, and showing excellent delamination resistance after hydrothermal treatment.

### Means for Solving the Problems

The present invention relates to a gas barrier film comprising: a base film having an inorganic compound layer formed on one side thereof; and a (meth)acrylic silane coupling agent layer and an organic barrier layer (Y) that are laminated in this order on the inorganic compound layer, the organic barrier layer (Y) comprising a polymer of a polyvalent metal salt of an unsaturated carboxylic acid compound (a) and a vinyl alcohol polymer (b).

### Effect of the Invention

The gas barrier film of the present invention has transparency and excellent gas barrier properties against oxygen, water vapor and the like, and shows excellent delamination resistance after hydrothermal treatment.

### Preferred Mode for Carrying Out the Invention

### Base Film

The base film on which the inorganic compound layer is formed, constituting the gas barrier film of the present invention, is a film composed of a thermoplastic resin.

Examples of the thermoplastic resin include various known thermoplastic resins such as polyolefins (polyethylene, polypropylene, poly 4-methyl-1-pentene, polybutene and the like), polyesters (polyethylene terephthalate, polybutylene terephthalate, polyethylene naphthalate and the like), polyamides (nylon-6, nylon-66, polymetaxylene adipamide and the like), polyvinyl chloride, polyimide, ethylene/vinyl acetate copolymers and saponified products thereof, polyvinyl alcohol, polyacrylonitrile, polycarbonate, polystyrene and ionomer, and mixtures of two or more of these. Among these, thermoplastic resins having excellent stretchability and transparency, such as polypropylene, polyester and polyamide are preferred, and polyesters such as polyethylene terephthalate and polyethylene naphthalate are especially preferred because of their excellent gas barrier properties, heat resistance and the like.

As the base film of the present invention, a biaxially-stretched film, especially a biaxially-stretched film comprising a polyester such as polyethylene terephthalate or polyethylene naphthalate is especially preferred.

The thickness of the base film of the present invention is within the range of usually 1 to 500 μm, preferably 3 to 400 μm, more preferably 5 to 300 μm.

### <Inorganic Compound Layer>

The inorganic compound layer formed on one side of the base film of the present invention is a layer composed of an inorganic element such as silicon, aluminum, titanium, zirconium, tin, magnesium or indium; or an oxide, nitride or fluoride of an inorganic element; or a complex of two or more of these. The inorganic compound layer may be formed by various known methods such as the CVD method (plasma CVD method, CAT-CVD method and the like); vapor deposition including the PVD method; film formation methods including the sputtering method; and dry film formation. The thickness of the inorganic compound layer is within the range of usually 0.1 to 1000 nm, preferably 1 to 500 nm, more preferably 3 to 200 nm.

Among these materials of an inorganic compound layer, aluminum oxide, silicon oxide, inorganic nitride and the like are excellent in the gas barrier properties, and aluminum oxide, silicon oxide and silicon nitride oxide are especially preferred because of their excellent transparency.

On the surface of the base film on which the inorganic compound layer is to be formed, an adhesion-promoting layer is preferably formed using the adhesive used for the later-mentioned adhesive layer, in order to improve adhesiveness to the inorganic compound layer.

### <(Meth)acrylic Silane Coupling Agent>

The (meth)acrylic silane coupling agent to be used as the (meth)acrylic silane coupling agent layer is a (meth)acrylic silane coupling agent represented by the General Formula (I) below.

The term “(meth)acryl” means one or both of acryl and methacryl.

### [Chemical Formula 1]

{In General Formula (I), R¹ represents methyl, R² represents methoxy, ethoxy or 2-methoxyethoxy, R³ represents a functional group comprising acryl and/or methacryl, and n represents an integer of 1 or more.}

Specific examples of these (meth)acrylic silane coupling agents include 3-methacryloxypropylmethyldimethoxysilane, 3-methacryloxypropyltrimethoxysilane, 3-methacryloxypropylmethyldiethoxysilane, 3-methacryloxypropyltriethoxysilane and 3-acryloxypropyltrimethoxysilane.

Among these coupling agents, 3-acryloxypropyltrimethoxysilane and 3-methacryloxypropyltrimethoxysilane are especially preferred.

The thickness of the (meth)acrylic silane coupling agent layer of the present invention is usually within the range of 3 to 400 nm, preferably within the range of 5 to 100 nm.

<Organic Barrier Layer (Y) Comprising Polymer (a) of Polyvalent Metal Salt of Unsaturated Carboxylic Acid Compound and Vinyl Alcohol Polymer (b)>

The layer (Y) constituting the gas barrier film of the present invention is a layer comprising a polymer of a polyvalent metal salt of an unsaturated carboxylic acid compound (a) and a vinyl alcohol polymer (b) (which may be hereinafter simply referred to as “organic barrier layer”).

The layer (Y) comprising a polymer of a polyvalent metal salt of an unsaturated carboxylic acid compound (a), which constitutes the gas barrier film of the present invention, is a layer that can be obtained by polymerization of a polyvalent metal salt of an unsaturated carboxylic acid.

### <Unsaturated Carboxylic Acid Compound>

The unsaturated carboxylic acid compound that forms the polyvalent metal salt of an unsaturated carboxylic acid compound used for the polymer of a polyvalent metal salt of an unsaturated carboxylic acid compound (a) is a carboxylic acid compound comprising an α,β-ethylenic unsaturated group such as an acrylic acid, methacrylic acid, maleic acid or itaconic acid group. The compound has a degree of polymerization of less than 20, and is preferably a monomer or a polymer having a degree of polymerization of not more than 10. In cases where a polymer having a degree of polymerization of more than 20 (macromolecular compound) is used, formation of the later-mentioned salt with a polyvalent metal compound may be incomplete, and, as a result, the layer obtained by polymerization of the metal salt may have poor gas barrier properties under high humidity. These unsaturated carboxylic acid compounds may be used individually or as a mixture of two or more of these.

Among these unsaturated carboxylic acid compounds, monomers are preferred since they easily form salts by complete neutralization with a polyvalent metal compound, and a gas barrier laminate such as a gas barrier film prepared by laminating a polymer layer obtained by polymerizing the salt on at least one side of a base material layer has especially excellent gas barrier properties under high humidity.

### <Polyvalent Metal Compound>

The polyvalent metal compound as a component forming the polyvalent metal salt of an unsaturated carboxylic acid compound of the present invention is a metal belonging to Group 2A to 7A, Group 1B to 3B or Group 8 of the periodic table, or a metal compound thereof. Specific examples of the polyvalent metal compound include divalent and higher valent metals such as magnesium (Mg), calcium (Ca), strontium (Sr), barium (Ba), iron (Fe), Cobalt (Co), nickel (Ni), copper (Cu), zinc (Zn) and aluminum (Al); and oxides, hydroxides, halides, carbonates, phosphates, phosphites, hypophosphites, sulfates and sulfites of these metals. Among these metal compounds, divalent metal compounds are preferred, and magnesium oxide, calcium oxides, barium oxide, zinc oxide, magnesium hydroxide, calcium hydroxide, barium hydroxide, zinc hydroxide and the like are especially preferred. In cases where these divalent metal compounds are used, the gas barrier properties of the film obtained by polymerization of the salt of the unsaturated carboxylic acid compound has especially excellent gas barrier properties under high humidity. At least one of these polyvalent metal compounds are used, and only one, or a combination of two or more, of the polyvalent metal compounds may be used. Among these polyvalent metal compounds, Mg, Ca, Zn, Ba and Al are preferred, and Zn is especially preferred.

### <Polyvalent Metal Salt of Unsaturated Carboxylic Acid Compound>

The polyvalent metal salt of an unsaturated carboxylic acid compound as a component constituting the polymer of a polyvalent metal salt of an unsaturated carboxylic acid compound (a) of the present invention is the salt produced from the unsaturated carboxylic acid compound having a degree of polymerization of less than 20 and the polyvalent metal compound. The polyvalent metal salt of an unsaturated carboxylic acid compound may be either a single type or a mixture of two or more types. Among such polyvalent metal salts of unsaturated carboxylic acid compounds, zinc (meth)acrylate is especially preferred because of excellent hydrothermal resistance of the polymer layer obtained therewith.

<Vinyl Alcohol Polymer (b)>

The vinyl alcohol polymer (b) contained in the layer (Y) is a polymer comprising vinyl alcohol as a major component of polyvinyl alcohol, ethylene/vinyl alcohol copolymer, modified vinyl alcohol polymer or the like.

The polyvinyl alcohol is not limited as long as it can be mixed, and the polyvinyl alcohol has a degree of polymerization within the range of preferably 100 to 3000, more preferably 200 to 2500, most preferably 300 to 2000. In cases where the degree of polymerization is within such a range, the polyvinyl alcohol can be prepared as an aqueous solution with which the base material layer can be easily coated, and the stretchability and the gas barrier properties of the film may be excellent. The degree of saponification is not less than 90%, preferably not less than 95%, and excellent gas barrier properties can be obtained within this range. Further, in view of the water resistance and the stretchability, an olefin-containing polyvinyl alcohol may be used. The olefin content is 0 to 25 mol %, preferably 1 to 20 mol %, more preferably 2 to 16 mol %. The olefin is preferably one whose number of carbon atoms is not more than 4, and examples of the olefin include ethylene, propylene, n-butene and isobutene. In view of the water resistance, ethylene is most preferred.

The content of the vinyl alcohol polymer (b) contained in the layer (Y) is usually within the range of 2 to 40% by weight, preferably within the range of 5 to 30% by weight, in terms of the amount of the vinyl alcohol polymer (b) with respect to the total amount (100 mass %) of the polymer of a polyvalent metal salt of an unsaturated carboxylic acid compound (a) and the vinyl alcohol polymer (b). By inclusion of the vinyl alcohol polymer (b) within such a range, a gas barrier film having excellent flexibility can be obtained.

As the vinyl alcohol polymer (b), a modified vinyl alcohol polymer comprising a reactive functional group is preferred, and a modified vinyl alcohol polymer (b1) comprising a functional group reactive with the polyvalent metal salt of an unsaturated carboxylic acid compound is especially preferred since it has excellent water resistance.

<Modified Vinyl Alcohol Polymer (b1)>

Examples of the modified vinyl alcohol polymer (b1) of the present invention include: those produced by modification of the vinyl alcohol polymer (b) by binding a reactive group(s) by, for example, addition of, replacement with, or esterification with, various known groups having reactivity (reactive groups); and those produced by saponification of a copolymer obtained by copolymerization of a vinyl ester such as vinyl acetate with an unsaturated compound comprising a reactive group. Examples of the reactive polymerizable groups include a (meth)acrylate group, (meth)acryloyl group, (meth)acrylamide group, vinyl group, allyl group, styryl group, thiol group, silyl group, acetoacetyl group and epoxy group.

The terms “(meth)acrylate”, “(meth)acryloyl” and “(meth)acrylamide” mean one or both of acrylate and methacrylate, one or both of acryloyl and methacryloyl, and one or both of acrylamide and methacrylamide, respectively, and the same applies hereinafter.

The amount of reactive groups may be set appropriately, but, in cases where the amount of OH groups in the vinyl alcohol polymer as the substrate is too small, the inherent gas barrier properties of the vinyl alcohol polymer may be deteriorated, so that the amount of reactive groups is usually within the range of 0.001 to 50 mol % (with respect to the total of the reactive groups and the OH groups, 100 mol %).

Examples of the method for producing the modified vinyl alcohol polymer (b1) include: modification of the vinyl alcohol polymer (b) by binding a reactive group(s) by, for example, addition of, substitution with, or esterification with various known groups having reactivity (reactive groups); and saponification of a copolymer obtained by copolymerization of a vinyl ester such as vinyl acetate with an unsaturated compound comprising a reactive group. The modified vinyl alcohol polymer (b1) is not limited as long as it comprises a reactive group in the polymer molecule.

The modified vinyl alcohol polymer (b1) that may be used has a degree of polymerization within the range of usually 100 to 3000, preferably 300 to 2000. In view of the gas barrier properties of the polymer obtained by use of the polyvalent metal salt of an unsaturated carboxylic acid compound (a) in combination, the degree of saponification is preferably as high as 70 to 99.9%, especially preferably 85 to 99.9%.

Specific examples of the reactive group in the modified vinyl alcohol polymer (b1) include a (meth)acrylate group, (meth)acryloyl group, (meth)acrylamide group, vinyl group, allyl group, styryl group, thiol group, silyl group, acetoacetyl group and epoxy group. The amount of reactive groups in the modified vinyl alcohol polymer may be set appropriately, but, in cases where the amount of OH groups in the vinyl alcohol polymer as the substrate is too small, the inherent gas barrier properties of the vinyl alcohol polymer may be deteriorated, so that the amount of reactive groups is usually within the range of 0.001 to 50 mol % (with respect to the total of reactive groups and OH groups, 100 mol %).

The modified vinyl alcohol polymer (b1) is preferably soluble in water, lower alcohol, organic solvent or the like, and is especially preferably soluble in a water-lower alcohol mixed solvent.

By mixing, as a component, the modified vinyl alcohol polymer (b1) produced by modification with the reactive group(s) with the metal salt of an unsaturated carboxylic acid compound (a) to perform polymerization, a layer (Y) having improved gas barrier properties under low humidity composed of a polymer wherein at least a part of the modified vinyl alcohol polymer (b1) and the polyvalent metal salt of an unsaturated carboxylic acid compound (a) are bound to each other via a certain bond can be obtained.

Specific examples of such a modified vinyl alcohol polymer (b1) include: a (meth)acrylate group-modified vinyl alcohol polymer (b1A) produced by reacting a part of the OH groups in the substrate vinyl alcohol polymer with a carboxylic acid compound (s) comprising an α,β-ethylenic unsaturated group(s) such as an acrylic acid, methacrylic acid, maleic acid, fumaric acid or itaconic acid group(s), and/or a derivative(s) thereof, to introduce a (meth)acrylate group (s) to the vinyl alcohol polymer; a thiol group-modified vinyl alcohol polymer (b1B) comprising a thiol group (—SH group) at a part of the OH groups in the substrate vinyl alcohol polymer, which thiol group-modified vinyl alcohol polymer is obtained by, for example, a method wherein vinyl monomers comprising an isothiuronium salt or thiol acid ester are copolymerized with vinyl acetate, followed by decomposing the obtained polymer with an acid or a base to provide a thiol group (s), a method wherein a reactive functional group (s) is/are introduced to a side chain (s) of a vinyl alcohol polymer by a macromolecular reaction, or a method wherein a vinyl ester is polymerized in the presence of a thiol acid, followed by saponification of the obtained polymer to introduce a thiol group(s) to only a terminus/termini of the molecule; a silyl group-modified vinyl alcohol polymer (b1C) comprising a trialkoxysilane group such as a trimethoxysilane group or triethoxysilane group, tricarbonyloxysilane group or the like at a part of the OH groups in the substrate vinyl alcohol polymer, which silyl group-modified vinyl alcohol polymer is obtained by, for example, a method wherein a vinyl alcohol polymer, or a vinyl acetate polymer comprising a carboxyl group or hydroxyl group, is post-modified using a silylating agent such as an organohalogensilane, organoacetoxysilane or organoalkoxysilane to add a silyl group(s), or a method wherein a copolymer of vinyl acetate and a silyl group-containing olefin unsaturated compound such as vinyl silane or (meth)acrylamide-alkylsilane is saponified to introduce a silyl group (s) such as an alkoxysilyl group (s) and/or acyloxysilyl group(s), or a silanol group(s), which is/are a hydrolysates thereof, and/or a salt(s) thereof into the molecule; and an acetoacetyl group-modified vinyl alcohol polymer (b1D) comprising an acetoacetyl group at a part of the OH groups in the substrate vinyl alcohol polymer, which acetoacetyl group-modified vinyl alcohol polymer is obtained by, for example, a method wherein a vinyl alcohol polymer is dispersed in an acetic acid solvent and diketene is added to the resulting suspension, a method wherein a vinyl alcohol polymer is preliminarily dissolved in a solvent such as dimethylformamide or dioxane, and diketene is added to the resulting solution, or a method wherein a vinyl alcohol polymer is directly brought into contact with diketene gas or liquid diketene; as well as a modified vinyl alcohol polymer produced by adding a radically polymerizable group(s) such as a (meth)acrylamide group(s), allyl group(s), vinyl group(s), styryl group(s), intramolecular double bond(s) and/or vinyl ether group(s) into the molecule by various known methods such as a method wherein a reactive functional group(s) is/are introduced to a side chain(s) by copolymerizing monomers comprising a reactive functional group with vinyl acetate, followed by saponifying the resulting copolymer, a method wherein a reactive functional group(s) is/are introduced to a side chain(s) of polyvinyl alcohol by a macromolecular reaction, or a method wherein a chain transfer reaction is utilized to introduce a reactive functional group(s) to a terminus/termini; and a modified vinyl alcohol polymer produced by adding a cationic polymerizable group(s) such as a epoxy group(s) and/or glycidyl ether group(s).

A layer composed of a polymer obtained using, among these modified vinyl alcohol polymers (b1), a (meth)acrylate group-modified vinyl alcohol polymer (b1A) is excellent in the gas barrier property (oxygen barrier property) under high humidity and low humidity, and the layer does not show a decrease in the gas barrier property (hydrothermal resistance) after hydrothermal treatment. The layer also has flexibility, and, in cases where a laminate, especially a film, comprising such a layer formed therein is used as a packing material or the like, the heat-seal strength of the packaging material is improved.

<(Meth)acrylate Group-modified Vinyl Alcohol Polymer (b1A)>

The (meth)acrylate group-modified vinyl alcohol polymer (b1A) of the present invention comprises (meth)acryloyl groups in an amount (relative to —OH groups; esterification rate) within the range of preferably 0.001 to 50% more preferably 0.1 to 40%. In cases where the esterification rate is less than 0.001%, the hydrothermal resistance, flexibility and the like of the layer (Y) obtained may not be improved, while in cases where the esterification rate is more than 50%, the hydrothermal resistance, oxygen barrier property and the like of the layer (Y) obtained may not be improved.

The (meth)acrylate group-modified vinyl alcohol polymer (b1A) of the present invention is obtained by, for example, reacting a vinyl alcohol copolymer with (meth)acrylic acid or a (meth)acrylic acid derivative such as a (meth)acrylic acid halide, (meth)acrylic acid anhydride or (meth)acrylic acid ester in the presence or absence of a catalyst such as a Brønsted acid, Brønsted base, Lewis acid, Lewis base or metal compound.

The term “(meth)acrylic acid” means one or both of acrylic acid and methacrylic acid, and the same applies hereinafter.

Further, a (meth)acrylate group(s) may be indirectly introduced to a vinyl alcohol copolymer by reacting a vinyl alcohol copolymer with a (meth)acrylic acid derivative comprising, in the molecule, a functional group reactive with an OH group in a vinyl alcohol copolymer such as glycidyl (meth)acrylate or 2-isocyanatoethyl (meth)acrylate.

<Thiol Group-Modified Vinyl Alcohol Polymer (b1B)>

The thiol group-modified vinyl alcohol polymer (b1B) of the present invention is a polymer prepared by introducing a thiol group (s) to the molecule by a known method such as a method wherein vinyl monomers comprising an isothiuronium salt or thiol acid ester are copolymerized with vinyl acetate, followed by decomposing the obtained polymer with an acid or a base to provide a thiol group (s), a method wherein a reactive functional group (s) is/are introduced to a side chain (s) of a polyvinyl alcohol polymer by a macromolecular reaction, or a method wherein a thiol group (s) is/are introduced to only a terminus/termini of the molecule by polymerizing a vinyl ester such as vinyl formate, vinyl acetate, vinyl propionate, vinyl versatate, vinyl laurate or vinyl stearate in the presence of a thiol carboxylic acid including an organic thiol acid comprising a —COSH group, such as thiol acetic acid, thiol propionic acid or thiol butyric acid, followed by saponifying the obtained polymer. The rate of modification with a thiol group(s) is usually within the range of 0.1 to 50 mol %.

Examples of the thiol group-modified vinyl alcohol polymer (b1B) include “M-115” and “M-205”, which are manufactured and sold by Kuraray Co., Ltd. under the trade name “Kuraray M polymer”.

<Silyl Group-Modified Vinyl Alcohol Polymer (b1C)>

Examples of the silyl group-modified vinyl alcohol polymer (b1C) of the present invention include polymers comprising, in the molecule, a silyl group such as an alkoxysilyl group or an acyloxysilyl group, or a silanol group, which is a hydrolysate thereof, or a salt thereof, which silyl group-modified vinyl alcohol polymer is obtained by, for example,

a method in which a silyl group(s) is/are added to a vinyl alcohol polymer or to a vinyl acetate polymer comprising a carboxyl group or hydroxyl group by post-modification using a silylating agent, for example, an organohalogensilane such as trimethylchlorosilane, dimethyldichlorosilane, methyltrichlorosilane, vinyltrichlorosilane or diphenyldichlorosilane, an organoacetoxysilane such as trimethylacetoxysilane or dimethyldiacetoxysilane, or an organoalkoxysilane such as trimethoxysilane or dimethyldimethoxysilane; or

a method in which a copolymer of vinyl acetate and a silyl group-containing olefin unsaturated compound is saponified, wherein examples of the silyl group-containing olefin unsaturated compound include vinylsilanes such as vinyltrimethoxysilane, vinyltriethoxysilane, vinyltris-(β-methoxyethoxy)silane, vinyltriacetoxysilane, allyltrimethoxysilane, allyltriacetoxysilane, vinylmethyldimethoxysilane, vinyldimethylmethoxysilane, vinylmethyldiethoxysilane, vinyldimethylethoxysilane, vinylmethyldiacetoxysilane, vinyldimethylacetoxysilane, vinylisobutyldimethoxysilane, vinyltriisopropoxysilane, vinyltributoxysilane, vinyltrihexyloxysilane, vinylmethoxydihexyloxysilane and vinyldimethoxyoctyloxysilane; and (meth)acrylamido-alkylsilanes such as 3-(meth)acrylamido-propyltrimethoxysilane, 3-(meth)acrylamido-propyltriethoxysilane, 3-(meth)acrylamido-propyltri(β-methoxyethoxy)silane, 2-(meth)acrylamido-2-methylpropyltrimethoxysilane, 2-(meth)acrylamido-2-methylethyltrimethoxysilane, N-(2-(meth)acrylamido-ethyl)-aminopropyltrimethoxysilane, 3-(meth)acrylamido-propyltriacetoxysilane, 2-(meth)acrylamido-ethyltrimethoxysilane, 1-(meth)acrylamido-methyltrimethoxysilane, 3-(meth)acrylamido-propylmethyldimethoxysilane, 3-(meth)acrylamido-propyldimethylmethoxysilane, 3-(N-methyl-(meth)acrylamido)-propyltrimethoxysilane, 3-((meth)acrylamido-methoxy)-3-hydroxypropyltrimethoxysilane and 3-((meth)acrylamido-methoxy)-propyltrimethoxysilane. The amount of modification with a thiol group(s) is usually within the range of 0.1 to 50 mol %.

Examples of the silyl group-modified vinyl alcohol polymer (b1C) include “R-1130”, “R-2105” and “R-2130”, which are manufactured and sold by Kuraray Co., Ltd. under the trade name “Kuraray R polymer”.

<Acetoacetyl Group-Modified Vinyl Alcohol Polymer (b1D)>

The acetoacetyl group-modified vinyl alcohol polymer (b1D) of the present invention is obtained by reacting a solution, dispersion or powder of the vinyl alcohol polymer with diketene in the form of a liquid or gas, and has a degree of acetoacetylation within the range of usually 1 to 10 mol %, preferably 3 to 5 mol %.

Examples of the acetoacetyl group-modified vinyl alcohol polymer (b1D) include the polymers having the trade names “GOHSEFIMER Z100”, “GOHSEFIMER Z200”, “GOHSEFIMER Z200H” and “GOHSEFIMER Z210”, which are manufactured and sold by Nippon Synthetic Chemical Industry Co., Ltd.

The modified vinyl alcohol polymer is preferably soluble in water, lower alcohol, organic solvent or the like, and is especially preferably soluble in a water-lower alcohol mixed solvent.

If necessary, any one, or a combination of two or more, of solvents other than water, such as alcohols including methanol, ethanol and isopropanol; ketones such as acetone and methylethylketone; diethyl ether; and tetrahydrofuran; may be added to an aqueous solution of the vinyl alcohol polymer such as these modified vinyl alcohol polymers. Further, a wettability improver, antistatic agent and/or other additives may be added to the polyvinyl alcohol polymer as long as they do not inhibit the characteristics of the present invention.

### <Adhesive Layer>

The adhesive layer used for laminating the gas barrier film of the present invention with another film is composed of various known adhesives and the like. Examples of the adhesives for constituting the adhesive layer of the present invention include laminate adhesives composed of an organic titanium resin(s), polyethyleneimine resin(s), urethane resin(s), epoxy resin(s), acrylic resin(s), polyester resin(s), oxazoline group-containing resin(s), modified silicone resin(s) and alkyl titanate, polyester polybutadiene and/or the like, and one-component and two-component polyols and polyvalent isocyanates, aqueous urethanes and ionomers. Further, depending on the use of the adhesive, other additives such as a curing agent, silane coupling agent and/or the like may be added to the adhesive. Further, aqueous adhesives comprising as a main raw material an acrylic, vinyl acetate, urethane or polyester resin or the like may also be used. In cases where hydrothermal treatment such as retort treatment is carried out, a dry laminate adhesive such as a polyurethane adhesive is often used in view of the heat resistance and water resistance, and the adhesive is preferably a solvent-system two-component curable polyurethane resin

### <Gas Barrier Film>

The gas barrier film of the present invention is a gas barrier film comprising: the base film having an inorganic compound layer formed on one side thereof; and the (meth)acrylic silane coupling agent layer, and the organic barrier layer (Y) comprising a polymer of a polyvalent metal salt of an unsaturated carboxylic acid compound (a) and a vinyl alcohol polymer (b), which (meth)acrylic silane coupling agent layer and organic barrier layer (Y) are laminated in this order on the inorganic compound layer.

The gas barrier film of the present invention may further comprise an adhesive layer laminated on the layer (Y).

The gas barrier film of the present invention may further comprise the another film laminated on the adhesive layer.

By laminating a thermal adhesive layer on the other side (the side where the inorganic compound layer is not formed) of the base film having an inorganic compound layer formed on one side thereof, a gas barrier film suitable as a heat-sealable packaging film can be obtained.

The thermal adhesive layer is obtained from a known material(s) which is/are usually used for thermal adhesive layers, and examples of the material(s) include: homopolymers and copolymers of α-olefin such as ethylene, propylene, butene-1, hexene-1,4-methyl-pentene-1 and/or octene 1; compositions comprising one or more of polyolefins such as high-pressure low-density polyethylene, linear low-density polyethylene (the so-called LLDPE), high-density polyethylene, polypropylene, polypropylene random copolymers, polybutene, poly 4-methyl-pentene-1, low crystallinity or amorphous ethylene/propylene random copolymers, ethylene/butene-1 random copolymers and propylene/butene-1 random copolymers; ethylene/vinyl acetate copolymers (EVAs); ethylene/(meth)acrylic acid copolymers and metal salts thereof; and compositions comprising EVA and polyolefin.

In particular, a thermal adhesive layer obtained from an ethylene polymer such as high-pressure low-density polyethylene, linear low-density polyethylene (the so-called LLDPE) or high-density polyethylene is preferred because of its excellent low-temperature heat sealability and heat seal strength.

### <Method for Producing Gas Barrier Film>

The gas barrier film of the present invention can be produced by applying the (meth)acrylic silane coupling agent on the inorganic compound layer of the base film having an inorganic compound layer formed on one side thereof, thereby forming a (meth)acrylic silane coupling agent layer, which is then coated with a solution prepared by mixing a solution containing a polyvalent metal salt of an unsaturated carboxylic acid compound having a degree of polymerization of less than 20 (s) with the vinyl alcohol polymer (b) at a desired ratio, followed by polymerizing the polyvalent metal salt of an unsaturated carboxylic acid compound having a degree of polymerization of less than 20 to form an organic barrier layer (Y) comprising a polymer of the polyvalent metal salt of an unsaturated carboxylic acid compound (a) and the vinyl alcohol polymer (b), and, as required, forming the adhesive layer on the layer (Y).

In terms of the (meth)acrylic silane coupling agent, a (meth)acrylic silane coupling agent solution is prepared by diluting, in a solvent, the (meth)acrylic silane coupling agent or a hydrolysate of the (meth)acrylic silane coupling agent. The hydrolysis may be promoted by allowing the hydrolysis to proceed under acidic conditions. Examples of the solvent include water, alcohols such as methanol, ethanol and 2-propanol.

The concentration of the (meth)acrylic silane coupling agent in the solution is within the range of 0.01 to 20%, preferably 0.1 to 5%.

Examples of the method that may be employed for coating the inorganic compound layer of the base film having an inorganic compound layer formed thereon with the (meth)acrylic silane coupling agent solution include various known methods such as methods in which the inorganic compound layer is coated with the solution using a coater (application), methods by spraying, and methods by application using a brush or the like. After the coating with the (meth)acrylic silane coupling agent solution, drying is performed at a temperature of about 40 to 120° C. to allow formation of the (meth)acrylic silane coupling agent layer.

Examples of the method for coating with the (meth)acrylic silane coupling agent solution or the like include methods using various known coaters such as an air-knife coater; gravure coaters such as a direct gravure coater, gravure offset, arc gravure coater, gravure reverse and jet nozzle gravure coater; reverse roll coaters such as a top feed reverse coater, bottom feed reverse coater and nozzle feed reverse coater; five roll coater; lip coater; bar coater; bar reverse coater; and die coater.

The coating with the solution containing a (meth)acrylic silane coupling agent is carried out such that the amount of the solution is 0.003 to 0.4 g/m², preferably 0.003 to 0.1 g/m².

In preparation of the solution containing a polyvalent metal salt of an unsaturated carboxylic acid compound having a degree of polymerization of less than 20 (s), contained in the organic barrier layer (Y), the unsaturated carboxylic acid compound may be preliminarily reacted with the polyvalent metal compound to provide the polyvalent metal salt of the unsaturated carboxylic acid compound, followed by preparing the solution therewith; or the unsaturated carboxylic acid compound and the polyvalent metal compound may be directly dissolved in a solvent to prepare the solution of the polyvalent metal salt.

In particular, in cases where a polyvalent metal salt of an unsaturated carboxylic acid compound obtained by preliminarily reacting the unsaturated carboxylic acid compound with the polyvalent metal compound is used, the obtained polymer of the polyvalent metal salt of the unsaturated carboxylic acid compound (a) basically does not contain a free carboxyl group, so that a gas barrier having better gas barrier properties can be obtained, which is preferred.

In cases where the unsaturated carboxylic acid compound and the polyvalent metal compound are directly dissolved in a solvent, that is, in cases where a solution containing the unsaturated carboxylic acid compound and the polyvalent metal compound is used in the method for producing a gas barrier film of the present invention, the chemical equivalence ratio of the polyvalent metal compound added is preferably more than 0.3 with respect to the unsaturated carboxylic acid compound. In cases where a mixed solution containing the polyvalent metal compound at a chemical equivalence ratio of not more than 0.3 is used, the polymer layer contains a large amount of free carboxylic acid groups, and this may result in a stretched film having low gas barrier properties. The upper limit of the amount of the polyvalent metal compound added is not limited. However, since, in cases where the polyvalent metal compound is added at a chemical equivalence ratio of more than 1, the amount of unreacted molecules of the polyvalent metal compound is large, so that the chemical equivalence ratio of the polyvalent metal compound added may be usually not more than 5, preferably not more than 2.

The chemical equivalence ratio in the present invention means the chemical equivalence ratio of the polyvalent metal compound with respect to the unsaturated carboxylic acid compound, and is calculated according to the equation below.

Chemical equivalence ratio=(number of moles of polyvalent metal compound)×(number of valences of polyvalent metal compound)/number of moles of carboxyl groups contained in unsaturated carboxylic acid compound

For example, if 37 g of calcium hydroxide (molecular weight, 74 g/mol) as the polyvalent metal compound and 72 g of acrylic acid monomers (molecular weight, 72 g/mol) as the unsaturated carboxylic acid compound are mixed together, the chemical equivalence ratio is 1.

In cases where a mixture of the unsaturated carboxylic acid compound and the polyvalent metal compound is used, a polyvalent metal salt of the unsaturated carboxylic acid compound is formed during the process of dissolving the unsaturated carboxylic acid compound and the polyvalent metal compound in the solvent. For securing the formation of the polyvalent metal salt, the mixing is preferably carried out for not less than 1 minute.

Examples of the solvent used for the solution containing the polyvalent metal salt of an unsaturated carboxylic acid compound, the vinyl alcohol polymer (b) and the (meth)acrylic silane coupling agent include water, lower alcohols such as methyl alcohol, ethyl alcohol and isopropyl alcohol; and organic solvents such as acetone and methyl ethyl ketone; and mixed solvents of two of more of these. Water is most preferred.

Examples of the method that may be employed for coating the (meth)acrylic silane coupling agent layer with the solution prepared by mixing the solution containing a polyvalent metal salt of an unsaturated carboxylic acid compound having a degree of polymerization of less than 20 (s) with the vinyl alcohol polymer (b) at a desired ratio include various methods such as methods in which the inorganic compound layer is coated with the solution using a coater (application), methods by spraying, and methods by application using a brush or the like.

Examples of the method for coating with the solution containing a polyvalent metal salt of an unsaturated carboxylic acid compound (s) or the like include methods using one or more of various known coaters such as an air-knife coater; gravure coaters such as a direct gravure coater, gravure offset, arc gravure coater, gravure reverse and jet nozzle gravure coater; reverse roll coaters such as a top feed reverse coater, bottom feed reverse coater and nozzle feed reverse coater; five roll coater; lip coater; bar coater; bar reverse coater; and die coater. In cases where coating with the solution containing the solution containing a polyvalent metal salt of an unsaturated carboxylic acid compound having a degree of polymerization of less than 20 (s) and the vinyl alcohol polymer (b) is carried out, the coating may be carried out such that the amount of the solution is 0.01 to 50 g/m², preferably 0.1 to 20 g/m².

When the polyvalent metal salt of an unsaturated carboxylic acid compound or the like is dissolved, various additives may be added as long as the object of the present invention is not deteriorated, and examples of the additives include monomers and low-molecular-weight compounds such as other unsaturated carboxylic acid (di)ester compounds including methyl (meth)acrylate and ethyl (meth)acrylate, and vinyl ester compounds such as vinyl acetate; lubricants; slip agents; antiblocking agents; antistatic agents; anti-clouding agents; pigments; dyes; and inorganic and organic fillers. Further, for improving the wettability with the base material layer, a surfactant(s) and/or the like may be added.

Examples of the method for polymerizing the polyvalent metal salt of an unsaturated carboxylic acid compound having a degree of polymerization of less than 20 contained in the solution with which the (meth)acrylic silane coupling agent layer was coated, which solution contains the solution containing the polyvalent metal salt of an unsaturated carboxylic acid compound having a degree of polymerization of less than 20 (s) and the vinyl alcohol polymer (b), include various known methods such as methods by irradiation of an ionizing radiation, heating, or the like.

In cases where an ionizing radiation is used, the ionizing radiation is not limited as long as it is an energy ray having a wavelength region within the range of 0.0001 to 800 nm, and examples of such an energy ray include α-ray, β-ray, γ-ray, X-ray, visible light, ultraviolet ray and electron beam. Among these ionizing radiations, visible light having a wavelength region within the range of 400 to 800 nm, ultraviolet ray having a wavelength region within the range of 50 to 400 nm, and electron beam within the range of 0.01 to 0.002 nm are preferred since they can be easily handled and generated with apparatuses that are widely used.

In cases where visible light or ultraviolet ray is used as the ionizing radiation, a photoinitiator needs to be added to the solution containing a polyvalent metal salt of an unsaturated carboxylic acid compound. As the photoinitiator, a known photoinitiator may be used, and examples of the photoinitiator include radical photoinitiators produced and sold under trade names for 2-hydroxy-2-methyl-1-phenyl-propane-1-one (manufactured by Ciba Specialty Chemicals K.K.; trade name, Darocur 1173), 1-hydroxy-cyclohexyl-phenyl ketone (manufactured by Ciba Specialty Chemicals K.K.; trade name, Irgacure 184), bis(2,4,6-trimethylbenzoyl)-phenylphosphine oxide (manufactured by Ciba Specialty Chemicals K.K.; trade name, Irgacure 819), 1-[4-(2-hydroxyethoxy)-phenyl]-2-hydroxy-2-methyl-1-propane-1-one (manufactured by Ciba Specialty Chemicals K.K.; trade name, Irgacure 2959), α-hydroxyketone, acylphosphine oxide, a mixture of 4-methylbenzophenone and 2,4,6-trimethylbenzophenone (manufactured by Lamberti Chemical Specialty; trade name, Esacure KT046), Esacure KT55 (manufactured by Lamberti Chemical Specialty) and 2,4,6-trimethylbenzoyldiphenylphosphine oxide (manufactured by Lambson Fine Chemicals; trade name, Speedcure TPO).

Further, a polymerization promoter may be added in order to increase the degree of polymerization or the polymerization rate, and examples of the polymerization promoter include N,N-dimethylamino-ethyl-(meth)acrylate and N-(meth)acryloyl-morpholine.

In cases where the polymerization of the polyvalent metal salt of an unsaturated carboxylic acid compound is carried out by irradiation of an ionizing radiation, the dose of irradiation of the ionizing radiation is within the range of preferably 1 to 1000 mJ/cm², more preferably 5 to 300 mJ/cm², especially preferably 10 to 200 mJ/cm². At a dose within such a range, a gas barrier laminate having a polymerization rate of not less than 80%, preferably not less than 90% can be stably obtained.

### EXAMPLES

The present invention is described below in more detail by way of Examples, but the present invention is not limited by these Examples as long as the spirit of the present invention is not exceeded.

The values of physical properties and the like in Examples and Comparative Examples were determined by the following evaluation methods.

### <Evaluation Methods>

### [Preparation of Multilayer Film for Measurement of Physical Properties]

On one side of an unstretched polypropylene film having a thickness of 70 μm (manufactured by Mitsui Chemicals Tohcello, Inc.; trade name, RXC-21), an ester-type adhesive (9 parts by weight of a polyester adhesive (manufactured by Mitsui Chemicals Polyurethanes, Inc.; trade name, Takelac A525), 1 part by weight of an isocyanate curing agent (manufactured by Mitsui Chemicals Polyurethanes, Inc.; trade name, Takenate A52) and 7.5 parts by weight of ethyl acetate) was applied, and the film was then dried, followed by laminating the resultant on the barrier surface of each of the gas barrier laminate films obtained in Examples and Comparative Examples (dry lamination), to obtain multilayer films (samples before retort treatment)

Each of the multilayer films was folded such that the unstretched polypropylene film faces inward, and two sides of the resultant were heat-sealed to form the film into the shape of a bag. Thereafter, 40 cc of water was added to the bag as the content, and the remaining side of the bag was heat-sealed to prepare a bag. The obtained bag was subjected to retort treatment using a high-temperature high-pressure retort sterilizer at 120° C. for 30 minutes. Thereafter, water as the content was removed to obtain a retort-treated multilayer film (retort-treated sample).

[Oxygen Permeability [ml/(m/Day/MPa)]]

The multilayer films before and after the retort treatment obtained by the above method were subjected to measurement using OX-TRAN2/20 manufactured by MOCON Inc. according to JIS K 7126 at a temperature of 20° C. and a humidity of 90% R.H.

[Peel Strength (N/15 mm)]

Each of the multilayer films before and after the retort treatment obtained by the above method was collected as a piece having a width of 15 millimeters (mm), and, in order to allow peeling of the gas barrier laminate film to start, the unstretched polypropylene film was partially peeled from the laminate surface at a corner of the sample. Thereafter the 180-degree laminate peel strength was measured at a peel rate of 300 (mm/minute). Measurement of the samples after retort treatment was carried out in the wet state.

### [Peel Interface]

The peel surface of the gas barrier laminate film and the peel interface of the unstretched polypropylene film in the sample obtained after peeling by the above method were subjected to measurement of the strengths of Zn and Si with fluorescent X-ray, to identify the peel interface.

### (Abbreviations for Peel Interfaces in Table 1)

A: Adhesive layer and organic barrier layer

B: Organic barrier layer and silane coupling layer

C: Silane coupling layer and SiOx layer

D: Organic barrier layer and SiOx layer

E: Stretched polyethylene naphthalate and SiOx layer

F: Adhesive layer and SiOx layer

### <Preparation of Solution (Z): Hydrolysate of 3-Acryloxypropyltrimethoxysilane>

To 10 g of 3-acryloxypropyltrimethoxysilane (manufactured by Shin-etsu Chemical Co., Ltd.; trade name, KBM5103), 34.46 g of purified water was added, and 0.25 g of acetic acid was further added thereto, followed by stirring the resulting mixture for 20 minutes. Thereafter, 34.46 g of isopropyl alcohol was added to the mixture, to obtain the solution (Z) as a hydrolysate of 3-acryloxypropyltrimethoxysilane.

### <Preparation of Solution (Y): Hydrolysate of 3-Methacryloxypropyltrimethoxysilane>

To 10 g of 3-methacryloxypropyltrimethoxysilane (manufactured by Shin-etsu Chemical Co., Ltd.; trade name, KBM503), 34.46 g of purified water was added, and 0.25 g of acetic acid was further added thereto, followed by stirring the resulting mixture for 20 minutes. Thereafter, 34.46 g of isopropyl alcohol was added to the mixture, to obtain the solution (Y) as a hydrolysate of 3-methacryloxypropyltrimethoxysilane

<Preparation of Solution (X): Hydrolysate of N-2(aminoethyl) 3-Aminopropyltrimethoxysilane>

To 10 g of N-2(aminoethyl) 3-aminopropyltrimethoxysilane (manufactured by Shin-etsu Chemical Co., Ltd.; trade name, KBM603), 34.46 g of purified water was added, followed by stirring the resulting mixture for 20 minutes. Thereafter, 34.46 g of isopropyl alcohol was further added thereto, to obtain a hydrolysate of N-2(aminoethyl) 3-aminopropyltrimethoxysilane. The obtained hydrolysate was used as the solution (X).

### <Preparation of Solution (W): Hydrolysate of 3-Glycidoxypropyltrimethoxysilane>

To 10 g of 3-glycidoxypropyltrimethoxysilane (manufactured by Shin-etsu Chemical Co., Ltd.; trade name, KBM403), 34.46 g of purified water was added, and 0.25 g of acetic acid was further added thereto, followed by stirring the resulting mixture for 20 minutes. Thereafter, 34.46 g of isopropyl alcohol was added to the mixture, to obtain a hydrolysate of 3-glycidoxypropyltriethoxysilane. The obtained hydrolysate was used as the solution (W).

### <Preparation of Solution (V): Hydrolysate of 3-Aminopropyltrimethoxysilane>

To 10 g of 3-aminopropyltrimethoxysilane (manufactured by Shin-etsu Chemical Co., Ltd.; trade name, KBM903), 34.46 g of purified water was added, followed by stirring the resulting mixture for 20 minutes. Thereafter, 34.46 g of isopropyl alcohol was further added thereto, to obtain a hydrolysate of 3-aminopropyltrimethoxysilane. The obtained hydrolysate was used as the solution (V).

### <Preparation of Solution (U): Hydrolysate of Vinyltrimethoxysilane>

To 10 g of vinyltrimethoxysilane (manufactured by Shin-etsu Chemical Co., Ltd.; trade name, KBM1003), 34.46 g of purified water was added, and 0.25 g of acetic acid was further added thereto, followed by stirring the resulting mixture for 20 minutes. Thereafter, 34.46 g of isopropyl alcohol was added to the mixture, to obtain a hydrolysate of vinyltrimethoxysilane. The obtained hydrolysate was used as the solution (U).

### <Preparation of Solution (T): Hydrolysate of 3-Isocyanatepropyltriethoxysilane>

To 10 g of 3-isocyanatepropyltriethoxysilane (manufactured by Shin-etsu Chemical Co., Ltd.; trade name, KBE9007), 34.46 g of purified water was added, and 0.25 g of acetic acid was further added thereto, followed by stirring the resulting mixture for 20 minutes. Thereafter, 34.46 g of isopropyl alcohol was added to the mixture, to obtain a hydrolysate of 3-isocyanatepropyltriethoxysilane. The obtained hydrolysate was used as the solution (T).

### <Preparation of Solution (S)>

Using the composition composed of 89 mass % (in terms of the solid content ratio) of an aqueous zinc acrylate solution (liquid concentration, 30%; manufactured by Asada Chemical Industry Co., Ltd.), 2 mass % of N-(2-hydroxyethyl)acrylamide (manufactured by manufactured by Kohj in Holdings, Co., Ltd.) and 9 mass % of a vinyl alcohol polymer (the total of zinc acrylate, N-(2-hydroxyethyl)acrylamide and the vinyl alcohol polymer is 100 mass %), the solution (S) was obtained by mixing an aqueous solution of this composition (solute concentration, 15 (mass %)), a photoinitiator {1-[4-(2-hydroxyethoxy)-phenyl]-2-hydroxy-2-methyl-1-propane-1-one (manufactured by Ciba Specialty Chemicals K.K.; trade name, Irgacure 2959)} diluted with methyl alcohol to 25 mass %, and a surfactant (manufactured by Kao Corporation; trade name, Emulgen 120) such that their solid content ratios were 98.5%, 1.2% and 0.3%, respectively.

### Comparative Example 1

On the easy-adhesion layer of a 12-μm biaxially-stretched polyethylene naphthalate having an easy-adhesion layer obtained by application of a mixture of an aqueous acrylic resin solution, aqueous polyester urethane resin solution and oxazoline-group containing polymer (manufactured by Nippon Shokubai Co., Ltd.; EPOCROS WS-500), an SiOx film (layer) having a thickness of 20 nanometers (nm) was formed by vacuum deposition in a vacuum of 0.5×10⁻⁴ Torr using SiO as the deposition source, to obtain a gas barrier film.

### Example 1

On the SiOx layer side of the gas barrier film obtained in Comparative Example 1, the solution (Z) was applied using a bar coater such that the coating amount after drying was 0.015 g/m², and dried using a hot air drier at a temperature of 80° C. for 30 seconds, to obtain a silane coupling layer. On the silane coupling layer, the solution (S) was applied using a Mayer bar such that the coating amount after drying was 1.4 g/m², and dried using a hot air drier at a temperature of 40° C. for 15 seconds. Thereafter, the film was immediately fixed on a stainless steel plate with the coated surface facing upward, and ultraviolet ray was irradiated using a UV illuminator (manufactured by Eye Graphics Co., Ltd.; EYE GRANDAGE, Type ECS 301G1) at an accumulated light quantity of 220 mJ/cm², to allow polymerization to form an organic barrier layer, thereby obtaining a gas barrier laminate film.

The obtained gas barrier film was evaluated by the above-described methods. The results are shown in Table 1.

### Example 2

A gas barrier film was obtained in the same manner as in Example 1 except that the solution (Z) was applied to the gas barrier film obtained in Comparative Example 1 using a bar coater such that the coating amount after drying was 0.03 g/m².

The obtained gas barrier film was evaluated by the above-described methods. The results are shown in Table 1.

### Example 3

A gas barrier film was obtained in the same manner as in Example 1 except that the solution (Y) was applied to the gas barrier film obtained in Comparative Example 1.

The obtained gas barrier film was evaluated by the above-described methods. The results are shown in Table 1.

### Comparative Example 2

A gas barrier film was obtained in the same manner as in Example 1 except that the solution (X) was applied to the gas barrier film obtained in Comparative Example 1.

The obtained gas barrier film was evaluated by the above-described methods. The results are shown in Table 1.

### Comparative Example 3

A gas barrier film was obtained in the same manner as in Example 1 except that the solution (W) was applied to the gas barrier film obtained in Comparative Example 1.

The obtained gas barrier film was evaluated by the above-described methods. The results are shown in Table 1.

### Comparative Example 4

A gas barrier film was obtained in the same manner as in Example 1 except that the solution (V) was applied to the gas barrier film obtained in Comparative Example 1.

The obtained gas barrier film was evaluated by the above-described methods. The results are shown in Table 1.

### Comparative Example 5

A gas barrier film was obtained in the same manner as in Example 1 except that the solution (U) was applied to the gas barrier film obtained in Comparative Example 1.

The obtained gas barrier film was evaluated by the above-described methods. The results are shown in Table 1.

### Comparative Example 6

A gas barrier film was obtained in the same manner as in Example 1 except that the solution (T) was applied to the gas barrier film obtained in Comparative Example 1.

The obtained gas barrier film was evaluated by the above-described methods. The results are shown in Table 1.

### Comparative Example 7

A gas barrier film was obtained in the same manner as in Example 1 except that the solution (Z) was not applied.

The obtained gas barrier film was evaluated by the above-described methods. The results are shown in Table 1.

TABLE 1

| | 180° Peel | | Oxygen permeability | | 180° Peel | |
|---|---|---|---|---|---|---|
| | Strength (N/15 mm) | | (ml/m² · day · MPa) | | interface | |
| | Before retort | After retort | Before retort | After retort | Before retort | After retort |
| | treatment | treatment | treatment | treatment | treatment | treatment |
| Example 1 | 7 | 5 | 1> | 1> | A | A |
| Example 2 | 8 | 6 | 1> | 1> | A | A |
| Example 3 | 7 | 4 | 1> | 1 | A | A |
| Comparative | 8 | 4 | 7 | 11 | F | E |
| Example 1 | | | | | | |
| Comparative | 8 | 0.4 | 1> | 1> | A | B |
| Example 2 | | | | | | |
| Comparative | 7 | 1> | 1> | 8 | A | B |
| Example 3 | | | | | | |
| Comparative | 7 | 0.8 | 1> | 4.2 | A | B |
| Example 4 | | | | | | |
| Comparative | 6 | 0.5 | 1> | 1.8 | A | B |
| Example 5 | | | | | | |
| Comparative | 0.2 | 0.2 | 1> | 3 | B | B |
| Example 6 | | | | | | |
| Comparative | 0.1 | 0.1 | 1> | 1> | D | D |
| Example 7 | | | | | | |

### INDUSTRIAL APPLICABILITY

The gas barrier film is excellent in the gas barrier properties under high humidity, and, by taking advantage of such properties, the film can be applied to various uses. Preferred examples of the uses include packaging materials for various products, for example, packing materials for dry foods, wet foods, boiled/retort foods, supplement foods and the like, especially food packaging materials for contents requiring high gas barrier properties; packing materials for toiletry products such as shampoos, detergents, bath salts and aromatics; medical uses such as packaging bags, packaging container members and the like for pharmaceuticals including powders, granules and tablets, liquid pharmaceuticals (infusion bags), and medical instruments; packaging materials for electronic parts including hard disks, circuit boards and printed boards; barrier materials for flat-panel displays such as liquid crystal displays, plasma displays, inorganic/organic EL displays and electronic papers; barrier materials such as back sheets for solar cells; barrier materials for other electronic materials; barrier materials for vacuum insulation materials; and packaging materials for industrial products including ink cartridges; as well as protection materials for materials sensitive to permeation of oxygen gas and humidity such as electronic materials, precision parts and pharmaceuticals.

1. A gas barrier film comprising: a base film having an inorganic compound layer formed on one side thereof; and a (meth)acrylic silane coupling agent layer and an organic barrier layer (Y) that are laminated in this order on said inorganic compound layer, said organic barrier layer (Y) comprising a polymer of a polyvalent metal salt of an unsaturated carboxylic acid compound (a) and a vinyl alcohol polymer (b).

2. The gas barrier film according to claim 1, further comprising an adhesive laminated on said organic barrier layer (Y).

3. The gas barrier film according to claim 1, wherein the content of said vinyl alcohol polymer (b) in said organic barrier layer (Y) with respect to the total content, 100 mass %, of said polymer of a polyvalent metal salt of an unsaturated carboxylic acid compound (a) and said vinyl alcohol polymer (b) is 2 to 40 mass %.

4. The gas barrier film according to claim 1, wherein said vinyl alcohol polymer (b) in said organic barrier layer (Y) is a modified vinyl alcohol polymer (b1).

5. A gas barrier film comprising another film laminated on the surface of the adhesive layer of the gas barrier film according to claim 2.

6. The gas barrier film according to claim 2, wherein said vinyl alcohol polymer (b) in said organic barrier layer (Y) is a modified vinyl alcohol polymer (b1).
